(19) United States
(12) Patent Application Publication
(10) Pub. No.: US 2010/0073187 A1
(43) Pub. Date: Mar. 25, 2010

(54) METHODS AND APPARATUS FOR NO-TOUCH INITIAL PRODUCT DEPLOYMENT

(75) Inventors: Richard Mark CLAYTON, Manorville, NY (US); Leo GREELEY, Shoreham, NY (US); Tom Roslak, Northport, NY (US)

Correspondence Address: INGRASSIA FISHER & LORENZ, P.C. (Symbol), 7010 E. COCHISE ROAD, SCOTTSDALE, AZ, 85253-1406, US

(73) Assignee: SYMBOL TECHNOLOGIES, INC., Holtsville, NY (US)

(21) Appl. No.: 12/235,323

(22) Filed: Sep. 22, 2008

(51) Int. Cl. G05B 19/02

(52) U.S. Cl. 340/825.22

(57) ABSTRACT

A non-contact deployment method generally includes: configuring a component so that it is in a low-power state; receiving an activation signal (e.g., light, RFID, WiFi, Bluetooth, etc.); causing a deployment module within the component to wake up; and instructing the component to perform the appropriate deployment steps. The activation signal is preferably a type of signal that does not require special equipment, i.e., a signal that would conventionally be present within an environment in which a network is being deployed. The signal may be received, for example, while the component is within its shipping box or other enclosure.

### TECHNICAL FIELD

The present invention relates generally to components used in connection with radio frequency identification (RFID) systems, wireless local area networks (WLANs), and other such networks, and, more particularly, to methods of deploying devices in such networks.

### BACKGROUND

Radio frequency identification (RFID) systems have achieved wide popularity in a number of applications, as they provide a cost-effective way to track the location of a large number of assets in real time. In large-scale applications such as warehouses, retail spaces, and the like, many types of tags may exist in the environment. Likewise, multiple types of readers, such as RFID readers, active tag readers, 802.11 tag readers, Zigbee tag readers, etc., are typically distributed throughout the space in the form of entryway readers, conveyer-belt readers, mobile readers, etc., and may be linked by network controller switches and the like. Similarly, there has been a dramatic increase in demand for mobile connectivity solutions utilizing various wireless components and wireless local area networks (WLANs). This generally involves the use of wireless access points that communicate with mobile devices using one or more RF channels (e.g., in accordance with one or more of the IEEE 802.11 standards).

Despite these advances, the configuration and initial setup of network components remains time-consuming and labor-intensive. More particularly, such components must typically be removed from their packaging, powered up, and then placed in an appropriate configuration mode (e.g., to search for access points, etc.). Some prior art systems configure themselves in the context of an open or known access point configuration; however, this method requires the component to be powered-up, and such units cannot reasonably be shipped in a powered-on state with their radios active, as it would require significant power and limit shipping alternatives due to the RF signal.

In devices that incorporate a separate battery, the insertion of the battery may be used to initiate deployment. This approach is not applicable, however, in components that include an internal battery. As a result, such components typically require a combination of button presses or other interface inputs to initiate configuration, which is a time-consuming process.

Accordingly, it is desirable to provide improved methods and systems for initial deployment of WLAN and RFID components. Furthermore, other desirable features and characteristics of the present invention will become apparent from the subsequent detailed description and the appended claims, taken in conjunction with the accompanying drawings and the foregoing technical field and background.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a system in accordance with an exemplary embodiment of the present invention;

FIG. 2 is a conceptual block diagram of an exemplary embodiment of the present invention;

FIGS. 3A and 3B are conceptual block diagram of a particular embodiment of the present invention; and

FIG. 4 is a simplified flow-chart in accordance with the invention.

### DETAILED DESCRIPTION

The present invention generally relates to a non-contact method of initially deploying network devices. In this regard, the following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the 802.11 family of specifications, wireless networks, RFID systems and specifications, and other functional aspects of the system (and the individual operating components of the system) may not be described in detail herein. Furthermore, the connecting lines shown in the various figures contained herein are intended to represent example functional relationships and/or physical couplings between the various elements. Many alternative or additional functional relationships or physical connections may be present in a practical embodiment.

Without loss of generality, in the illustrated embodiment, many of the functions usually provided by a traditional access point (e.g., network management, wireless configuration, etc.) and/or traditional RFID readers (e.g., data collection, RFID processing, etc.) are concentrated in a corresponding RF switch. It will be appreciated that the present invention is not so limited, and that the methods and systems described herein may be used in conjunction with traditional access points and RFID readers or any other device that communicates via RF channels.

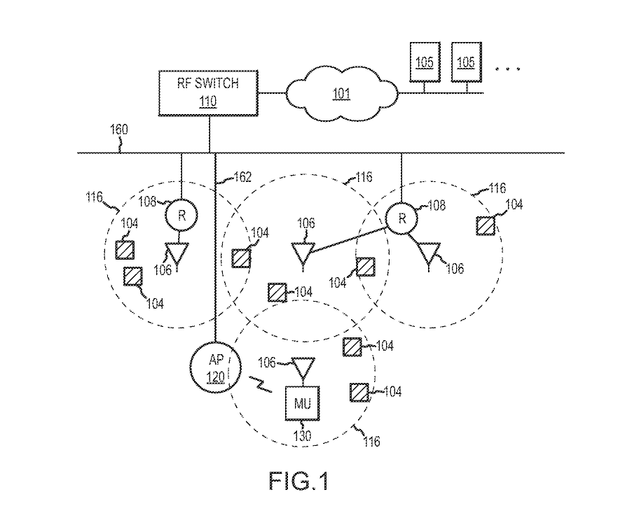

Referring to FIG. 1, in an example system useful in describing the present invention, a switching device 110 (alternatively referred to as an “RF switch,” “WS,” or simply “switch”) is coupled to a network 101 and 160 (e.g., an Ethernet network coupled to one or more other networks or devices) which communicates with one or more enterprise applications 105, which will typically include one or more inventory databases and other such well-known components (not illustrated).

One or more wireless access ports 120 (alternatively referred to as “access ports” or “APs”) are configured to wirelessly communicate with one or more mobile units 130 (or “MUs”). AP 120 suitably communicates with switch 110 via appropriate communication lines 160, 162 (e.g., conventional Ethernet lines, or the like). Any number of additional and/or intervening switches, routers, servers and other network components may also be present in the system.

A number of RF tags (“RFID tags,” or simply “tags”) 104 may be distributed throughout the environment. These tags, which may be of various types, are read by a number of RFID readers (or simply “readers”) 108 having one or more associated antennas 106 provided within the environment. The term “RFID” is not meant to limit the invention to any particular type of tag. The term “tag” refers, in general, to any RF element that can be communicated with and has an ID (or “ID signal”) that can be read by another component. In general, RFID tags (sometimes referred to as “transponders”) may be classified as either active, passive, or semi-active. Active tags are devices that incorporate some form of power source (e.g., batteries, capacitors, or the like) and are typically always “on,” while passive tags are tags that are exclusively energized via an RF energy source received from a nearby antenna. Semi-active tags are tags with their own power source, but which are in a standby or inactive mode until they receive a signal from an external RFID reader, whereupon they “wake up” and operate for a time just as though they were active tags. While active tags are more powerful, and exhibit a greater range than passive tags, they also have a shorter lifetime and are significantly more expensive. Such tags are well known in the art, and need not be described in detail herein.

RF Switch 110 determines the destination of packets it receives over networks 160 and 101 and routes those packets to the appropriate AP 120 if the destination is an MU 130 with which the AP is associated. Each WS 110 therefore maintains a routing list of MUs 130 and their associated APs 130. These lists are generated using a suitable packet handling process as is known in the art. Thus, each AP 120 acts primarily as a conduit, sending/receiving RF transmissions via MUs 130, and sending/receiving packets via a network protocol with WS 110. RF switch 110 can support any number of devices that use wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB.

Locationing, as performed by the RF switch 110 generally involves examining all of the RFID tag data available at a particular time and then using rules and locationing algorithms to determine the most likely location of the tags associated with the tag data. Such locationing typically involves utilizing various ranging techniques to determine symbolic distance or range measurement coupled with position estimation techniques that derive position estimates from collection of reference points and their associated range measurements.

Readers 108, each of which may be stationary or mobile, are suitably coupled via wired or wireless data links to RF switch 110, and may have multiple associated antennas 106. Each antenna 106 has an associated RF range (or “read point”) 116, which depends upon, among other things, the strength of the respective antenna 106. The read point 116 corresponds to the area around the antenna in which a tag 104 may be read by that antenna, and may be defined by a variety of shapes, depending upon the nature of the antenna (i.e., the RF range need not be circular or spherical as illustrated in FIG. 1). Furthermore, MU 130, as illustrated in FIG. 1, may incorporate its own RFID reader module such that it is configured to read tags 104 within range and then communicate the resulting tag information to RF switch 110 via AP 120. Location algorithms may also be augmented by incorporation of secondary location data available from tracking signals from the MU data communications radio (e.g., IEEE 802.11). This data may be used to provide localization data for lower range RFID tags, which may be out of the current range of any stationary reader. A reader 108 may also incorporate additional functionality, such as filtering, cyclic-redundancy checks (CRC), and tag writing, as is known in the art.

As described in further detail below, switch 110 includes hardware, software, and/or firmware capable of carrying out the functions described herein. Thus, switch 110 may comprise one or more processors accompanied by storage units, displays, input/output devices, an operating system, database management software, networking software, and the like. Such systems are well known in the art, and need not be described in detail. Switch 110 may be configured as a general purpose computer, a network switch, or any other such network host. In a preferred embodiment, switch 110 is modeled on a network switch architecture but includes RF network controller software (or “module”) whose capabilities include, among other things, the ability to allow configure and monitor readers 108 and antennas 106.

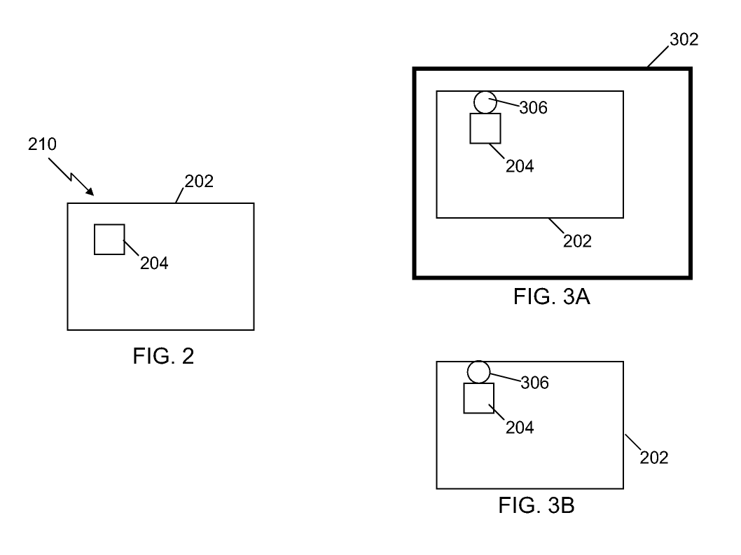

FIG. 2 depicts a generic component 202, which might represent an RFID reader, an access point, a network switch, a mobile unit, or any other component suitable for network communication. In accordance with the present invention, component 202 includes a deployment module 204, which may be implemented in hardware, software, firmware, or a combination thereof, and which communicates with the processor and other conventional components located within component 202 (not illustrated).

Deployment module 204 is configured to receive some form of activation signal 210 and, in response, instruct component 202 to enter an initial configuration or deployment mode. Activation signal 210 comprises any suitable non-contact signal using any convenient wavelength or signal type, e.g., RF, light, UV light, magnetic field, IR, an RFID signal, a WiFi energy signal, a Bluetooth signal, Zigbee, WiMax, or any other signal now known or later developed.

In a particular embodiment, shown in FIGS. 3A and 3B, component 202 includes a light sensor 306 coupled to deployment module 204, and is packaged within a substantially opaque enclosure with various packing materials, etc. Light sensor 306 is preferably oriented “up,” or facing the direction most likely to experience a light change upon opening, and may also provide traditional LED functionality. In other embodiments, an output LED may be used as light sensor 306. Light sensor 306 may be polled at regular intervals (e.g., every few minutes) to reduce power, or other detection approaches may be used that generate a signal without polling. For example, a static circuit may be provided that is activated by the activation signal, which then starts up sequential logic circuitry (such as a microcontroller) to thereby initiate deployment. It will be understood that an LED may be used as both a transmitter and a receiver in a particular application.

Referring to FIGS. 3A and 3B, when enclosure 302 is opened (e.g., at the end-user's network location), the ambient light signal 310 is sensed by deployment module 204. In an alternate embodiment, a single light sensor 310 is incorporated into an enclosure that includes two or more such network components 202, and is configured such that both components 202 undergo deployment substantially simultaneously in response to a signal from the single light sensor 310.

The components 202 may have already been factory pre-configured prior to packaging, or may be in a low-power state with only generic settings in place from the factory. Once activated, the components may seek out a secure configuration source to establish a working state or configuration.

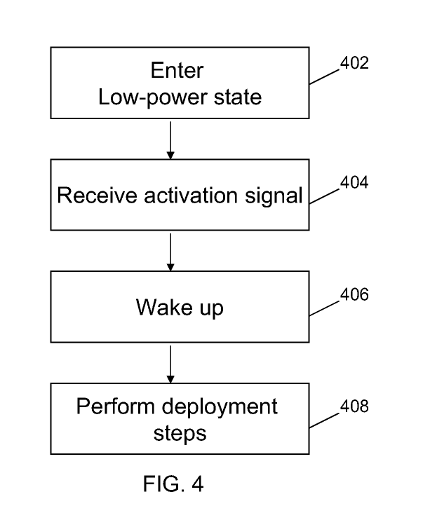

Referring to the simplified flowchart shown in FIG. 4, a method in accordance with the present invention generally includes, initially, configuring component 202 so that it is in a low-power state (402). This low-power state preferably allows deployment module 204 to operate, and wait for appropriate signals, while not dissipating a substantial amount of energy. Any associated RF radios are preferably disabled. In a typical application, component 202 will then be packaged for shipping, as depicted in FIG. 3A.

Next, in step 404, component 202 receives the activation signal. As mentioned previously, this signal may be of any convenient type, and is selected to cause deployment module 204 to wake up (step 406), and instruct component 202 to perform the appropriate deployment steps (step 408). Activation signal 210 is preferably a type of signal that does not require special equipment, i.e., a signal that would conventionally be present within an environment in which a network is being deployed (IR, RFID, WiFi, light, or the like). This signal may be received, for example, while component 202 is within its shipping box or other enclosure. In one embodiment, a wrapper or barrier is removed to expose the component 202 to a signal that is part of the natural environment (e.g., light, oxygen, humidity, etc.). In another embodiment a unique signal is deliberately sent to wake up component 202 (e.g., sound, an RFID signal, a WLAN signal, etc.). In yet another embodiment, an inhibiting signal is removed to initiate deployment (e.g., a magnet embedded or otherwise integrated with the enclosure's removeable lid).

In one embodiment, deployment module 204 is configured to receive two or more activation signals before initializing deployment, thereby helping to prevent accidental deployment. Toward this end, deployment module 204 may also be configured to re-enter low power state (402) if a particular action or signal is not received within a predetermined time of receiving the activation signal. This “secondary signal” used to confirm activation may relate, for example, to a particular orientation or change of orientation of the component 202.

It should be appreciated that the example embodiment or embodiments described herein are not intended to limit the scope, applicability, or configuration of the invention in any way. For example, these methods may be used in connection with standard barcode readers and the like. In general, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. An method for providing initial deployment of a component within a network, the method comprising:
placing the component within a low-power state;
sending an activation signal to the component;
placing the component in a powered-up state in response to receipt of the activation signal; and
performing a deployment procedure associated with the component.

2. The method of claim 1, further including, prior to the sending step, packaging the component within an enclosure such that the activation signal is blocked by the enclosure, and causing the enclosure to be moved to a remote location.

3. The method of claim 1, wherein the activation signal is a signal selected from the group consisting of WiFi signals, RFID signals, Bluetooth signals, and magnetic field signals.

4. The method of claim 1, wherein the activation signal comprises a light signal.

5. The method of claim 1, wherein the component is configured to receive the light signal when the enclosure is opened at the remote location.

6. The method of claim 5, wherein the enclosure further includes a second component, and wherein the first and second component are both configured to enter the powered-up state in response to the receipt of same light signal.

7. The method of claim 1, wherein the deployment procedure includes association with an access point.

8. A self-deploying network component configured to be packaged in a low-power state and then perform a deployment procedure in response to a non-contact activation signal received from an external source;

9. The self-deploying network component of claim 8, further including a deployment module configured to initiate the deployment procedure.

10. The self-deploying network component of claim 9, further including a light sensor coupled to the deployment module, wherein the non-contact activation signal is a light signal.

11. The self-deploying network component of claim 10, wherein the light sensor is an LED associated with normal operation of the network component.

12. The self-deploying network component of claim 10, comprising a component selected from the group consisting of an access point, a mobile unit, an RFID reader, a network switch, and a router.

13. A system for deploying a plurality of network component in a network, comprising:
a signal source configured to generate an activation signal;
a plurality of deployment modules, each provided within a respective network component, the deployment module configured to receive the activation signal from the signal source when the respective network component is in a low-power mode, and in response cause the respective network component to enter a powered-on mode and initiate a deployment procedure.

14. The system of claim 13, further including a plurality of activation signals, each associated with a type of said network components.

15. The system of claim 13, wherein the signal source is a natural part of the environment.

16. The system of claim 15, wherein the activation signal comprises a light signal.

17. The system of claim 13, wherein the activation signal is a signal selected from the group consisting of WiFi signals, RFID signals, Bluetooth signals, and magnetic field signals.

18. The system of claim 13, wherein the activation signal consists of the removal of an inhibiting signal.

19. The system of claim 18, wherein the inhibiting signal comprises a magnetic field removeably proximate to the network components.

20. The system of claim 13, wherein the network components are provided within an enclosure, and wherein the activation signal is communicated to the network components when the enclosure is opened.
